(19) United States
(12) Patent Application Publication
(10) Pub. No.: US 2025/0071818 A1
(43) Pub. Date: Feb. 27, 2025

(54) CONGESTION REDUCING METHOD PERFORMED BY A USER EQUIPMENT IN COMMUNICATION SYSTEMS

(71) Applicant: Continental Automotive Technologies GmbH, Hannover (DE)

(72) Inventors: Rikin Shah, Langen (DE); David Gonzalez Gonzalez, Egelsbach (DE); Reuben George Stephen, Singapore (SG)

(73) Assignee: Continental Automotive Technologies GmbH, Hannover (DE)

(21) Appl. No.: 18/726,141

(22) PCT Filed: Jan. 2, 2023
(86) PCT No.: PCT/EP2023/050028

§ 371 Date: Jul. 2, 2024

(30) Foreign Application Priority Data
Jan. 3, 2022 (DE) 10 2022 200 001.3

(51) Int. Cl. H04W 74/0833

(52) U.S. Cl. CPC H04W 74/0833

(57) ABSTRACT

Congestion reducing method performed by a user equipment (UE) in communication systems, characterized by, that the user equipment (UE) is prepared for transmitting uplink data (UL) and is in a passive status and after initiating a Random Access Channel procedure (RACH) the user equipment (UE) receives back off index from the base-station (gNB) and user equipment (UE) selects back off Index based on user equipment (UE) criteria related to at least one communication systems relevant criterion.

### CROSS-REFERENCE TO RELATED APPLICATIONS

The present application is a National Stage Application under 35 U.S.C. § 371 of International Patent Application No. PCT/EP2023/050028 filed on Jan. 2, 2023, and claims priority from German Patent Application No. 10 2022 200 001.3 filed on Jan. 4, 2022, in the German Patent and Trademark Office, the disclosures of which are herein incorporated by reference in their entireties.

### TECHNICAL FIELD

The invention relates to a decentralized method to reduce Random Access Channel (RACH) congestion in user equipment (UE), a network device set up to perform the method.

### BACKGROUND

The Third Generation Partnership Project (3GPP) has standardized Coverage Enhancement (CE) for Internet-of-Things (IoT) to connect devices in challenging radio conditions with cellular networks. CE is based on the principle of prolonged transmission time that exploits the fact that many IoT applications have relaxed requirements on data rate and latency, and the coverage can be significantly boosted by repeating transmissions for such applications. However, CE consumes a lot of radio resources and should be implemented carefully for different applications.

Evolution of wireless communication technologies toward the fifth-generation (5G) enables everything to be connected through the internet. For example, lots of information related to human activities have been recorded, monitored through various types of IoT applications (e.g., health monitoring, smart home, intelligent transportation, industrial automation), and exchanged through cellular networks. However, unfortunately, conventional cellular networks have not been designed to accommodate such diverse IoT applications. Accordingly, enormous efforts have been made to support the emerging IoT scenario in cellular networks, which is referred to massive machine-type communications (mMTC) or massive IoT (mIoT) as one of the main use cases of 5G.

In cellular networks, an extremely large number of IoT devices are expected to be deployed, where the number of connected devices will reach 500 billion by 2030. Each IoT device sporadically generates small-sized packets to report sensing information to the IoT server through a base station (BS/gNB). In particular, an IoT device stays out-of-connection with the BS to reduce energy consumption due to the sporadic packet generation. This implies that each of IoT devices should perform random access (RA) procedure to establish a connection with the BS, whenever transmitting data packets to the IoT server. The RA procedure adopted in the existing cellular systems such as LTE/LTE-A/5G consists of four-steps of handshaking procedure. Due to the densely deployed IoT devices in cellular IoT networks, simultaneous RA attempts at a certain RA slot (or, equivalently, physical RA channel (PRACH)) may cause collision problem. Collision problem highly causes the poor access performance (i.e., RA failure) at the device side. To be specific, IoT devices may spend considerable time to access the networks and thus the networks cannot guarantee acceptable end-to-end delay according to their access priority.

In cellular systems, a connection between each user equipment (UE) and the base-station (gNB, BS) is pre-required for data communications. For establishing a connection, a device/UE should proceed 4-steps of RA or 2-steps of RA procedure. It is summarized that the overall descriptions on the conventional RA procedure in cellular networks (e.g., LTE/LTE-A/5G) is as follows:
Step 1. Preamble transmissions: Each IoT device randomly selects a single RA preamble among a set of available RA preambles, and transmits it on the PRACH.
Step 2. Random access responses: The BS detects which preambles are active. In response to the detected preambles, the BS transmits random access response (RAR) messages, each of which consists of an RA preamble identifier (RAPID), a timing alignment (TA), an uplink grant (UG), and a temporary identifier. Each IoT device which transmitted a preamble at the first step waits for the RAR message containing the same RAPID. If there exists the corresponding RAR message, each device utilizes information within the message for the subsequent step (i.e., Step 3).
Step 3. Scheduled transmissions: Each IoT device transmits its scheduled message (e.g., connection request message) on the assigned uplink resource on physical uplink shared channel (PUSCH), indicated by the UG value contained in the RAR message received in the second step. In order to determine whether the resource collision on the used uplink resource occurs or not, each IoT device starts a contention resolution (CR) timer once the Step 3 message is transmitted.
Step 4. Acknowledgement: The BS echoes the identifiers of the IoT devices, whose transmitted scheduled messages are successfully decoded without any resource collisions. If each IoT device receives the correct acknowledgement (ACK) message before the CR timer expires, then it regards the RA attempt as a success. Otherwise, it regards the RA attempt as a failure and reattempts the RA procedure at the next-available RA slot after performing a back-off.

EP 3864921 describes a prioritization method for random access, comprising receiving one or more first packet flow for transmission, wherein the one or more first packet flow is assigned a respective access category queue, initiating a random access procedure for the first packet flow, receiving a packet of a second packet flow for transmission, wherein the second packet flow is assigned an access category queue having priority over the access category queue assigned to the first packet flow, issuing an indication configured to interrupt the random access procedure for the first packet flow, and performing a random access procedure for the received packet of the second packet flow wherein idle time slots previously sensed by the random access procedure for the first packet flow are considered as sensed also for the random access procedure for the second packet flow. Corresponding apparatus and computer program product are also disclosed.

WO2021135941A1 describes a method, performed by a User Equipment (UE) for a small data transmission, includes receiving, from a base station (BS), a configuration indicating a dedicated physical resource; transmitting the small data transmission based on the dedicated physical resource; and receiving an acknowledge (ACK) indicator indicating a successful reception from the BS, wherein the UE is in an inactive state to transmit the small data transmission.

US2021307073A1 describes a method and device from the perspective of a User Equipment (UE). The method includes the UE receiving a configuration, from a network node, indicating that Random Access Channel (RACH) occasion(s) of a first Random Access (RA) type are not configured. The method further includes the UE determining if RACH occasion(s) of the first RA type are shared with a second RA type or a third RA type, and/or includes the UE determining the starting point of preambles for the first RA type based on at least RA parameter(s) for more than one RA type.

WO2021165076A1 relates to a user equipment (UE), comprising a processor, which determines that a transmission of small data is to be performed. The UE is in an inactive state with at least one data connection to a radio base station. The UE is assigned at least with a cell-specific UE identification and a non-cell-specific UE identification. The processor determines which UE identification to use for the small data transmission, based on whether the UE, after having transitioned to the inactive state, has moved to the current radio cell from another radio cell. In case the UE has moved to the current radio cell from another radio cell, the non-cell-specific UE identification is used. In the other case, the cell-specific UE identification is used. A transmitter transmits a control message including the determined UE identification and transmits the small data using one of the at least one data connection.

WO2021002632A1 relates to a method and a device for controlling a load (overload) in a process of small data transmission of an RRC inactive terminal or an RRC idle terminal. An aspect provides a method and a device for controlling a load of small data by a terminal, the method comprising the steps of: triggering small data transmission in an RRC inactive state; transmitting Msg 3 or Msg A including small data to a base station; and receiving Msg 4 or Msg B including information for overload control from the base station.

KR20210005513A discloses a method for controlling overload during a small-amount data transmission procedure of an RRC INACTIVE terminal or RRC IDLE terminal, and an apparatus thereof. According to one aspect, the method for enabling a terminal to control the overload of a small amount of data includes the following steps of: triggering the transmission of a small amount of data in an RRC inactive state; transmitting Msg 3 or Msg A including a small amount of data to a base station; and receiving Msg 4 or Msg B including information for overload control from the base station.

Small Data Transmission (SDT) is configured by the gNB on a per DRB basis. The SDT procedure is initiated by UE in RRC_INACTIVE when data arrives only for DRB(s) for which SDT is configured. UE has to decide whether to perform data transmission in RRC_INACTIVE or RRC_CONNECTED when the data of the SDT-DRB arrives. Therefore, “Data volume threshold” is used for the UE to decide whether to do SDT or not. Small Data Transmission (SDT) can be performed by using 4-step RACH, 2-step RACH, or configured grant (CG) procedure. This invention is focusing on RACH based SDT, but this approach is not limited to this kind of application.

As shown in FIG. 3 and already described above the sequence of messages involves:
1) Msg1 (PRACH preamble);
2) Msg2 (RAR);
3) Msg3 (RRC Resume Request);
4) Msg4 (RRC Resume); and
5) Msg5 which can be used for the UL data.

This involves 5 or more messages which results in unnecessary power consumption, increase latency, and signaling overhead.

UE selects a preamble in the preamble group. gNB feedbacks a Random Access Response (RAR) to the UE which sends preamble in Msg1/MsgA. In RAR, the gNB indicates a Back-off Indicator (BI) considering the cell load. Once the UE is failed in RA, e.g., the RAR doesn't include the preamble that UE sent in Msg1/MsgA, or the contention resolution in Msg4/MsgB is considered not successful, UE will randomly select a back-off time between 0 and BI and retransmit the preamble after the back-off time.

The current backoff time selection is that the UE selects one random backoff time between 0 and the backoff parameter value (BPV). UEs with smaller backoff parameter value will select one backoff time between [0, small BPV] and the UEs with larger backoff parameter value will select one backoff time between [0, large BPV]. Like it is presented in FIG. 1, for example, if the backoff index (BI) field value is 10, Backoff Parameter value (BPV) is 320 ms.

According to backoff parameter value table in FIG. 1, for example, if UE1 receives BI value 10 at time T PRACH occasion, UE1 can send PRACH anytime in between 0 and 320 ms. If UE2 receives BI value 6 at time Δ+T PRACH occasion, UE2 can send PRACH anytime in between 0 and 80 ms. As a result, lower range of backoff time i.e., 0 to 80 ms is overlapped between UE1 & UE2 and there is a higher chance, where UE1 can select backoff time between 0 and 80 ms.

As lower range of backoff time is overlapped for all SDT UEs, more UEs will select backoff time in lower range of BPV. As a result, there is a high possibility of collision among multiple UEs during RACH procedure. Because of this high possibility of collision, UE might require a greater number of retransmissions of PRACH which would result more power consumption and signaling overhead that is not desirable for small data.

With the said the known approaches presented in the State of the Art for controlling to reduce RACH congestion led to the termination and repetition of the transmission. But with the presented approach their occurrence can be reduced.

### BRIEF SUMMARY

The described problem is solved by one embodiment of the congestion reducing method performed by a user equipment (UE) in communication systems, the user equipment (UE) is prepared for transmitting uplink data (UL) and is in a passive status and after initiating a Random Access Channel procedure (RACH) the user equipment (UE) receives a list of indexes (LoI) from the base-station (gNB) and user equipment (UE) ignores it, whereby every element of the list of indexes (LoI) is associated to specific time values, after the reception of the list of indexes (LoI) the user equipment (UE) performs a selection of the list of indexes (LoI) based on at least one communication systems relevant criterion for the proceeding of the transmission for the uplink data (UL).

Another embodiment of the congestion reducing method performed by a user equipment (UE) in communication systems is characterized by, that the user equipment (UE) is prepared for transmitting uplink data (UL) and is in a passive status and after initiating a Random Access Channel procedure (RACH) the user equipment (UE) receives back off index from the base-station (gNB) and user equipment (UE) selects back off Index based on user equipment (UE) criteria related to at least one communication systems relevant criterion.

Another embodiment is characterized by, that list of indexes (LoI) is the list of backoff indicators (BI) and the specific time values are the backoff parameter values (BVP) and the one communication systems relevant criterion is the data volume threshold (DVT) and/or the user equipment (UE) priority.

Another embodiment is characterized by, that the user equipment (UE) is prepared for transmitting uplink data (UL) and is in a passive status and after initiating a Random Access Channel procedure (RACH) the user equipment (UE) receives back off value parameters (BVP) from the base-station (gNB) and user equipment (UE) ignores it and selects back off parameter (BVP) based on user equipment (UE) criteria related to at least one communication systems relevant criterion.

Another embodiment is characterized by, that the communication system relevant criterion is the data volume threshold (DVT) and/or the user equipment (UE) priority.

Another embodiment is characterized by, that user equipment (UE) receives the mapping between the data volume threshold (DVT) and back off parameter (BPV) in a system information message.

Another embodiment is characterized by, that user equipment (UE) with larger data volume threshold (DVT) assigns highest Random Access Channel (RACH) priority.

Another embodiment is characterized by, that user equipment (UE) selects the back off parameter (BPV) corresponding to the data volume threshold (DVT) and with the user equipment (UE) priority whereby, if the user equipment (UE) priority is low the user equipment (UE) selects a higher the back off parameter (BPV) and if the user equipment (UE) priority is high the user equipment (UE) selects a lower back off parameter (BPV).

Another embodiment is characterized by, that the configuration of the user equipment (UE) priority for each user equipment (UE) in the communication system is realized by a dedicated radio resource control protocol (RRC) message.

Another embodiment is characterized by, that the configuration of the user equipment (UE) priority for each user equipment (UE) in the communication system is realized per logical channel.

The described problem is solved by one embodiment of the congestion reducing method performed by a base station (gNB) in communication systems, characterized by that a list of indexes (LoI) from the base-station (gNB), whereby every element of the list of indexes (LoI) is associated to specific time values and the specific time values are segmented into different levels and the segmented specific time values are associated with data volume threshold (DVT) and/or user equipment UE priority.

Another embodiment is characterized by, that the specific time values are the backoff parameter values (BVP).

Another embodiment is characterized by, that the base-station (gNB) configures lower backoff parameter values (BPV) for higher data volume threshold (DVT) and higher backoff parameter values (BPV) for lower data volume threshold (DVT).

Another embodiment is characterized by, that the base-station (gNB) updates the mapping between the data volume threshold (DVT) and back off parameter (BPV) based on the load situation of the communication system.

Another embodiment is characterized by, that if load situation of the communication system is high, the base-station (gNB) configures a longer window for higher data volume threshold (DVT).

Another embodiment is characterized by, that the segmentation of the backoff parameter values (BVP) results in into three blocks.

Another embodiment is characterized by an apparatus for congestion reducing performed by a user equipment (UE) in a wireless communication system, the apparatus comprising a wireless transceiver, a processor coupled with a memory in which computer program instructions are stored, said instructions being configured to implement steps of the claims 1 to 9.

Another embodiment is characterized by an apparatus for congestion reducing performed by a base station (gnB) in a wireless communication system, the apparatus comprising a wireless transceiver, a processor coupled with a memory in which computer program instructions are stored, said instructions being configured to implement steps of the claims 10 to 13.

User Equipment (UE) comprising an apparatus according to claim 14.

Base station (gNB) comprising an apparatus according to claim 15.

Wireless communication system for congestion reducing from a base station (gNB) to a user equipment (UE), wherein the base station comprises a processor coupled with a memory in which computer program instructions are stored, said instructions being configured to implement steps of claims 8 to 13, wherein the user equipment (UE) comprises a processor coupled with a memory in which computer program instructions are stored, said instructions being configured to implement steps of the claims 1 to 7.

Computer program product, comprising commands which, when executed by a computer, cause it to execute the method according to one or more of claims 1-7.

Computer-readable data carrier on which the computer program product according to claims 8 to 13 is stored.

Generally spoken, when UE triggers RACH procedure in RRC_INACTIVE, it selects backoff parameter value (BPV) correspond to the data volume threshold and/or UE priority.

For example, base-station (gNB) segmented backoff parameter value (BPV) in three level i.e., BPV1, BPV2 and BPV3. BPV1, BPV2 and BPV3 are associated with data volume threshold and/or UE priority. Based on the data volume threshold (DVT) and/or priority, UE selects the backoff time from non-overlapping backoff indexes ranges. So, RACH congestion would reduce due to a non-overlap in backoff time. As a result, UE would not require transmitting more number of PRACH transmission, thus signaling overhead as well as power consumption would reduce.

Further, the invention proposes a computer program with computer program instructions that implement the method when executed on a computer with a communication interface. In addition, the invention proposes a computer program product that provides computer-readable signals which, when read by a computer, provide a computer program according to the third aspect. The computer-readable signals can be provided on a physically embodied data carrier or in a carrier signal.

The following description assumes that each of the network devices in a group of network devices can receive messages from all other network devices in the group. For this purpose, the network devices may be located at a distance that allows direct communication with each other, but it is also possible to route the communication of the network devices via one or more transmit/receive units acting as repeaters, so that a group exists even if not all network devices can communicate directly with all other network devices in the group. The repeaters can also be connected to each other via another network by type of access point. Receiving messages from other network devices is also referred to as “listening” or “monitoring” in the following description.

The Frequency Correction Channel (FCCH) is a downlink channel that helps the terminal to find the frequency channels in which a BCCH is transmitted. The FCCH is always transmitted in time slot 0 of the frequency channel in which a BCCH is located. Therefore, by receiving the FCCH, the time slot numbering can be found, followed by the SCH and thus the BCCH. In the FCCH, only frequency correction bursts are sent.

The Synchronization Channel (SCH) is a downlink channel that helps the device to recognize the channel structure and find the BCCH. The SCH is always transmitted exactly in the eighth time slot after the FCCH. By receiving the SCH, the frame structure can be recognized and thus the BCCH can be found. In the SCH, only the current frame number and the BSIC are sent.

The Broadcast Control Channel (BCCH and PBCCH) is a downlink channel that provides the end device with information about the emitting cell. These are i.e. the PLMNidentifier of the network, cell ID, location area, channel structure, access restrictions, availability of data services and frequencies of the neighboring cells.

The Random Access Channel (RACH and PRACH) is an uplink channel in which the end device can request a connection from the network.

The paging channel (PCH and PPCH) is a downlink channel that serves to send individual end devices a connection request from the network, for example because of an incoming call or a short message. A device called in this way, when it receives this connection request, will try to request a dedicated channel for further communication via the RACH or PRACH. The base station then assigns a channel to the end device via the Access Grant Channel (AGCH).

The Notification Channel (NCH) is a downlink channel that serves to inform end devices about calls from the VGCS and the DDPS. For this purpose, the identifiers of the corresponding groups of participants are transmitted in this channel.

Every network device has a unique identifier or identification assigned to it, e.g., a MAC address. In addition, each network device or user equipment (UE) has at least one interface set up for bidirectional communication.

The interface and the user equipment (UE) may be set up for the use of certain frequencies or frequency bands or channels. The use can be made according to one of several possible modulation and coding schemes, whereby the selection of the modulation and coding scheme can be contextual. Exemplary modulation schemes are the orthogonal frequency modulation method (OFDM), quadrature amplitude modulation (QAM) or variants thereof, and the direct sequence spread spectrum (DSSS).

### BRIEF DESCRIPTION OF THE DRAWINGS

In the following, the invention is explained in more detail on the basis of the embodiments with reference to the accompanying figures. All figures are purely schematic and not scaled.

FIG. 1 shows the BI field value.

FIG. 2 shows components of the date elements.

FIG. 3 shows a known sequence of messages with step 1 to 5 with 5 messages.

FIG. 4 shows UE triggers RACH procedure in RRC_INACTIVE, selecting BPV.

FIG. 5 shows UE triggers RACH procedure in RRC_INACTIVE, it selects BPV.

FIG. 6 shows the running method on UE side.

FIG. 7 shows the running method on gNB side.

FIG. 8 shows gNB configures backoff parameter range for DVT1 and backoff parameter range for DVT2.

FIG. 9a shows an example of Priority per UE for UE1.

FIG. 9b shows an example of Priority per UE for UE2.

FIG. 10a shows an example of Priority per Logical channel, if UE1 has total amount of data from LCH1 which is below DVT1, it selects backoff time between BPV1 and BPV2.

FIG. 10b shows an example of priority per logical channel, if UE1 has total amount of data from LCH2 which is above DVT1, it selects backoff time between BPV2 and BPV3.

FIG. 11 shows UE selects BPV based on the ratio of priority to DVT.

FIG. 12 shows UE selects BPV based on the data volume threshold.

FIG. 13 shows the case when the sum-user data is maximized.

FIG. 14 shows the case when fairness is promoted (min-max latency).

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc.), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category M1, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

The same or similar elements are provided with the same or similar reference signs in the figures.

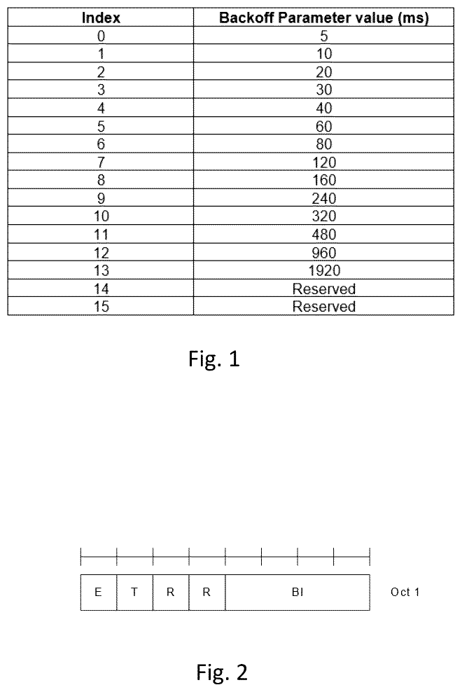

FIG. 1 shows, if the BI field value is 10, Backoff Parameter value is 320 ms. This means UE can send PRACH any time in between 0 and 320 ms from now.

FIG. 2 shows structure of Backoff Indicator (BI). Backoff Indicator is a special MAC sub-header that carries the parameter indicating the time delay between a PRACH and the next PRACH.

The bit field shown in FIG. 2, the BI (Backoff Indicator) field is made up of 4 bits, implying that it can carry the value from 0-15. Each of these value maps to a specific time value as shown in the following table. For example, if the BI field value is 10, Backoff Parameter value is 320 ms. This means UE can send PRACH any time in between 0 and 320 ms from now.

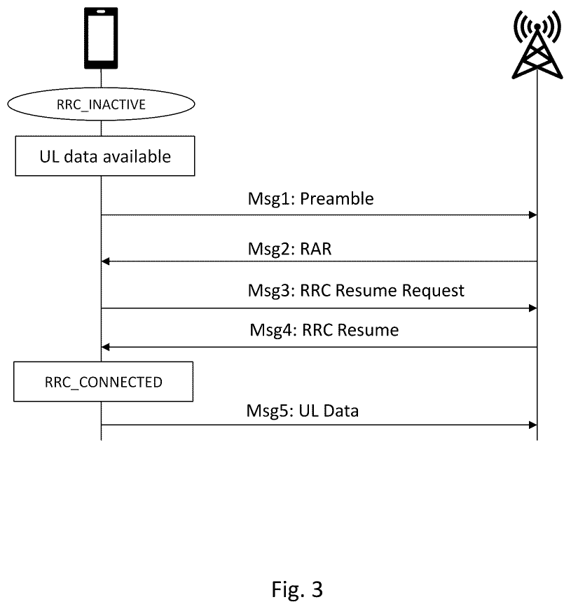

FIG. 3 shows that gNB and UE message exchange. The sequence of messages involves:
1) Msg1 (PRACH preamble);
2) Msg2 (RAR);
3) Msg3 (RRC Resume Request);
4) Msg4 (RRC Resume); and
5) Finally, Msg5 which can be used for the UL data.

This involves 5 or more messages which results in unnecessary power consumption, increase latency and signaling overhead.

FIG. 4 shows UE triggering RACH procedure in RRC_INACTIVE, it selects BPV correspond to the: data volume threshold and/or UE priority. RACH is a PHY and MAC layer process. For a UE to initiate RACH it has to get the some information before it can send a RACH to the gNB, UE gets this information from the gNB. It needs Information such as which PRACH preamble to use and when to send PRACH i.e. PRACH occasions. For Example: Backoff parameter values tables are segmented into different level and such segmented backoff parameter values are associated with data volume threshold and/or UE priority. Based on the data volume threshold (DVT), UE selects the backoff time instead of choosing it randomly. So, RACH congestion would reduce due to a non-overlap in backoff time. As a result, UE would not require transmitting more number of PRACH transmission, thus signaling overhead as well as power consumption will be reduced.

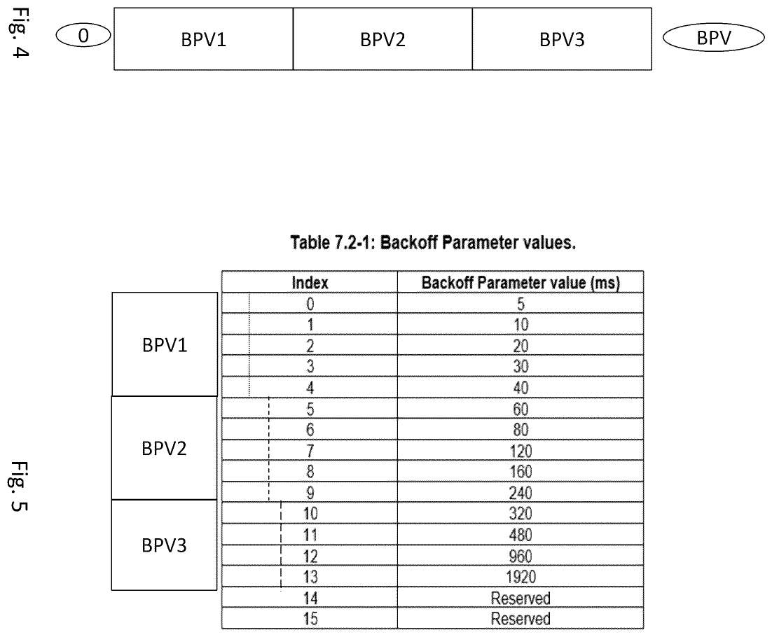

FIG. 5 shows base station (gNB) segmented backoff parameter value (BPV) in three level i.e., BPV1, BPV2 and BPV3. Such BPV1, BPV2 and BPV3 are associated with data volume threshold and/or UE priority.

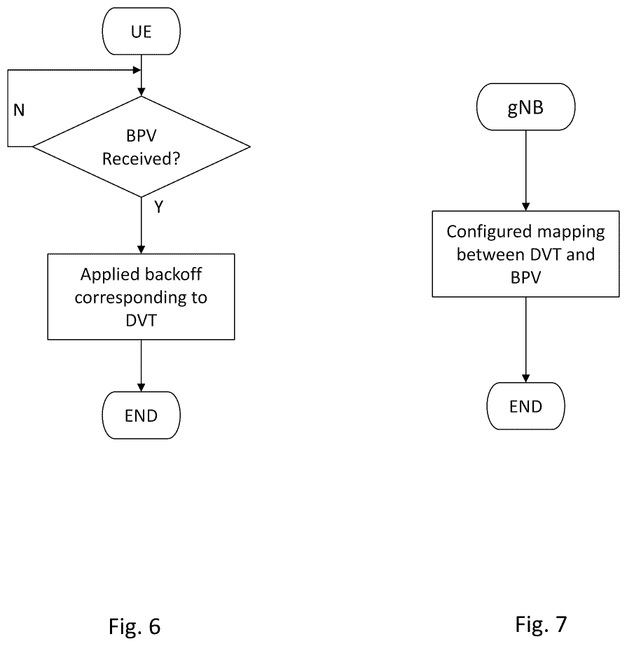

FIG. 6 the process on UE-side. UE checks if BPV is received, in case of yes applied backoff corresponding to DVT is proceed and the sequence ends. If BPV is not received, the sequence checks for BPV reception.

FIG. 7 b shows the process on base station side (gNB). A configured mapping between DVT and BPV is proceeded and then the sequence ends.

When UE triggers RACH procedure in RRC_INACTIVE, it selects BPV correspond to the data volume threshold whereby gNB configures lower BPV for higher data volume threshold and higher BPV for lower data volume threshold. UE with larger data volume threshold owns highest RACH priority. UE receives mapping between the data volume threshold and BPV in system information message. gNB can update such mapping depending on the overall load situation. If load is higher, gNB can configure longer window for higher data volume threshold. Beneficially, UE with higher amount of buffer can transmit data quickly. High priority UE with lower amount of buffer may face delay to transmit the data.

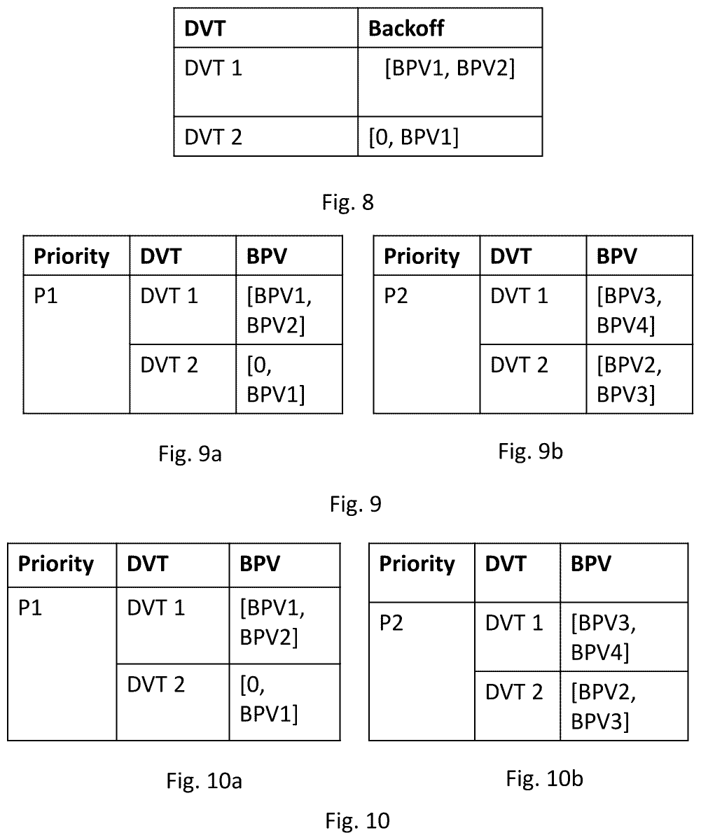

FIG. 8 shows for example, gNB configures backoff parameter range for DVT1 as [BPV1, BPV2] and backoff parameter range for DVT2 should be [0, BPV1] where DVT1<DVT2. If UE1 has total amount of data below DVT1, it selects backoff time between BPV1 and BPV2. Similarly, if UE2 has total amount of data above DVT1, it selects backoff time between 0 and BPV1. PRACH transmission is prioritized for UE2 due to higher data volume threshold.

A further embodiment is characterized by when UE triggers RACH procedure in RRC_INACTIVE, it selects BPV correspond to the data volume threshold along with Priority whereby low priority UE selects higher BPV and high priority UE selects lower BPV. Following are two possibilities to configure priority. Option 1: Priority is configured per UE through dedicated RRC message, with the benefit of Reducing signaling overhead. Option 2: Priority is configured per logical channel with the benefit: UE selects backoff time based on services.

The association between data volume threshold and BPV are corresponding to each priority and is broadcasted in system information. The base station (gNB) can update such mapping depending on the overall load situation. If network load is higher, gNB can configure longer window for high priority UE.

FIG. 9 shows the Example of Priority per UE: if UE1 is configured with priority P1 and has total amount of data less than DVT2, FIG. 9a then it selects backoff time between BPV1 and BPV2. Similarly, in FIG. 9b, if UE2 is configured with priority P2, and has total amount of above DVT1 then it selects backoff time between BPV2 and BPV3.

FIG. 10 shows example of priority per Logical channel: UE1 is configured with two logical channels. Logical channel 1 is associated with Higher priority P1 and logical channel 2 is associated with lower priority P2, like in FIG. 10a shown. If UE1 has total amount of data from LCH1 which is below DVT1, it selects backoff time between BPV1 and BPV2, like in FIG. 10a shown. If UE1 has total amount of data from LCH2 which is above DVT1, it selects backoff time between BPV2 and BPV3, like in FIG. 10b shown. If UE1 has total amount of data from Logical channel 1 and Logical channel 2 which is above DVT2, it selects backoff time between 0 and BPV1 corresponding to higher priority of logical channel, like in FIG. 10a shown.

Although the method according to the invention has been described above with reference to wirelessly networked network devices, it is also possible to use the method in a network device connected by a wired bus, for example in a vehicle. In the case of wired networked network devices, a dynamic change in configuration, which is also covered by the procedure, is rather unlikely, but not excluded. For example, network devices could be connected to each other via the bus, which independently switch between active and inactive modes and do not monitor communication in inactive mode in order to save energy.

An application of the method described herein is not limited to vehicles or generally mobile network devices, but it can be used in all cases in which network devices temporarily organize themselves, e.g. in smart factories.

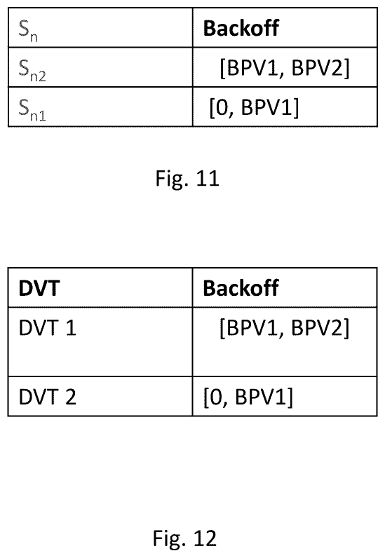

FIG. 11 an alternative embodiment in which UE selects BPV based on the ratio of priority to DVT. As an example, Sₙ=Priority/DVT whereby UE's Priority is configured through dedicated RRC signaling and DVT is received through system information. The association between Sₙ and BPV are broadcasted through system information message. UE selects BPV depending on the result of Sₙ as shown in FIG. 11, where S_{n2>}Sₙ₁, whereby the benefit is reducing signaling overhead compared to Embodiment 2 shown in FIGS. 9 and 10. Generally for this embodiment generalization is possible with other functions that suitably capture the tradeoff of priority and DVT.

FIG. 12 shows a further alternative embodiment in which UE selects BPV based on the data volume threshold as shown in the table below. This table has to specify in the specification, whereby the benefit: no additional signaling is required, UE selects same BPV regardless of whether gNB is overloaded or not and BPV is static and cannot change it dynamically.

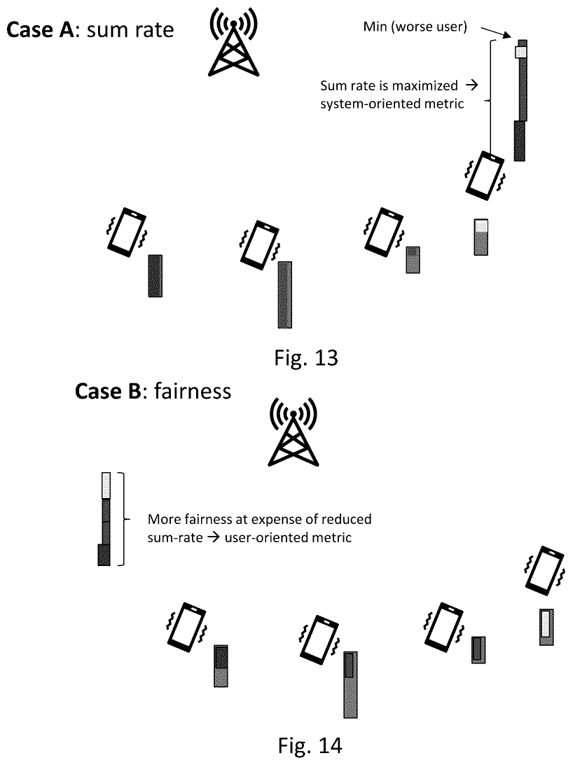

FIGS. 13 and 14 are displaying the wide application of the invention in a broad manner. Different mapping schemes can favor different objectives, e.g. sum-user data or min-max (latency). The main approach here is to link different tables with different policies that favor different global objectives. In the FIG. 13 case A illustrates the case when the sum-user data is maximized, e.g., system perspective, while case B in FIG. 14 is a scenario where fairness is promoted (min-max latency). Different mapping tables (Data Volume—Backoff interval) can be indicated by the gNB using higher layer signaling in a semi-static manner depending on some criterion, e.g., user distribution, system load, etc.

A beneficial user Equipment (UE) is configured with multiple ra-ResponseWindow whereby ra-ResponseWindow is associated with different type of UEs. The UE with higher power saving can be configured as a smaller ra-ResponseWindow. For example, SDT UE is configured with smaller ra-ResponseWindow than non-SDT UE. The basestation (gNB) configures multiple ra-ResponseWindow based on the UE types through system information message. As an example, UE types can be SDT UE, IoT UE, NTN UE, RedCap UE or non-SDT UE. gNB configures individual ra-ResponseWindow to each type of UE.

Broadcast access to communication media shared by multiple network devices/UEs requires organization and control so that each of the network devices has the ability to send data-containing messages over the media. The shared communication medium is characterized by the fact that only one of the network devices is allowed to transmit at any time, while all other network devices can receive, but are not allowed to send. Examples of shared communication media include bus systems to which multiple network devices are directly connected, or frequencies or frequency ranges or channels of wireless communication systems on which multiple network devices communicate with each other. In the case of spatial multiplex on the same frequencies, frequency ranges or channels, e.g. by means of directional antennas, which transmit directed into individual areas or sectors or receive in these areas or sectors, the shared communication medium is the frequency or frequency range or channel used by the network devices within this spatial area or sector.

When determining the transmission access, a prioritization of the transmission of messages or the data contained therein may be provided, for example, according to their importance or urgency, or a prioritization of the transmission access of network devices regardless of the content of the messages they send.

Access to shared communication media can be controlled by a central control body that allows each network participant to broadcast the shared communication medium for a specified period of time, taking into account different parameters or properties assigned to him. In doing so, the central control authority can ensure that a fair distribution of access times among all network participants takes place.

Access can also be controlled without a central control authority by applying certain agreements or rules in each of the network devices as a policy, which stipulate that a network device must first check whether another network device is currently broadcasting on the communication medium before it is allowed to send itself in the case of a communication medium not currently used by another network device. An exemplary protocol for access control without a central control authority in cable networks is known under the acronym CSMA/CD (Carrier Sense Multiple Access/Collision Detection, Multiple Access with Carrier Inspection and Collision Detection). In wireless networks, a variant of this is used, which is known under the acronym CSMA/CA (Carrier Sense Multiple Access/Collision Avoidance, multiple access with carrier inspection and collision avoidance).

This invention is primary focusing on Small Data Transmission WI. However, it could also apply to other WIs like URLLC, NTN, eMBB, IIoT, IoT, NTN-IoT, NR-U, V2X/v2V/sidelink.

The monitoring of signals on other frequencies or channels can be used, for example, to determine the respective signal strength and derive a decision for policy determination.

A computer program product according to the invention contains accordingly commands which, when executed by a computer, cause it to execute one or more embodiments and further developments of the method described above.

The computer program product may be stored on a computer-readable medium. The data carrier may be physically embodied, for example as a hard disk, CD, DVD, flash memory or the like, but the data carrier may also include a modulated electrical, electromagnetic or optical signal that can be received by a computer by means of a corresponding receiver and stored in the memory of the computer.

A vehicle with a described user equipment (UE) according to the invention can form a group with other suitably equipped vehicles that are within communication range, which exchange messages or information via a shared communication medium, for example about a condition of a roadway or dangerous situations located on a road ahead.

In this case, land, air or water vehicles can communicate equally with each other, provided that they have a network device according to the invention. For example, drones in the airspace above a road can transmit information about the road to cars or trucks. In addition, a fixed device on a road or other location may be used to form a group with vehicles in range, at least temporarily, i.e., to exchange messages or information via a communication medium.

1. A method of reducing congestion performed by a user equipment (UE) in a communication system, wherein the user equipment (UE) is prepared for transmitting uplink data (UL) and is in a passive status and after initiating a Random Access Channel procedure (RACH) the user equipment (UE) receives a received back off index from a base-station (gNB) and the user equipment (UE) selects a selected back off Index based on user equipment (UE) criteria related to at least one communication system relevant criterion.

2. The method of claim 1, wherein the communication system relevant criterion is a data volume threshold (DVT) and/or a user equipment (UE) priority.

3. The method of claim 2, wherein the user equipment (UE) receives a mapping between the data volume threshold (DVT) and a back off parameter (BPV) in a system information message.

4. The method of claim 1, wherein a user equipment (UE) with a larger data volume threshold (DVT) assigns a highest Random Access Channel (RACH) priority.

5. The method of claim 4, wherein the user equipment (UE) selects the back off parameter corresponding to the data volume threshold (DVT) and with the user equipment (UE) priority whereby, if the user equipment (UE) priority is low, then the user equipment (UE) selects a higher the back off parameter, and, if the user equipment (UE) priority is high, then the user equipment (UE) selects a lower back off parameter.

6. The method of claim 5, wherein a configuration of the user equipment (UE) priority for each user equipment (UE) in the communication system is realized by a dedicated radio resource control protocol (RRC) message.

7. The method of claim 5, wherein a configuration of the user equipment (UE) priority for each user equipment (UE) in the communication system is realized per logical channel.

8. A method of reducing congestion performed by a base station (gNB) in a communication system, wherein a list of indexes (LoI) from the base-station (gNB), whereby every element of the list of indexes (LoI) is associated to specific time values, and the specific time values are segmented into different levels, and the segmented specific time values are associated with a data volume threshold (DVT) and/or a user equipment UE priority.

9. The method of claim 8, wherein the specific time values are backoff parameter values (BVP).

10. The method of claim 9, wherein the base-station (gNB) configures a plurality of lower backoff parameter values (BPV) for a higher data volume threshold (DVT) and a plurality of higher backoff parameter values (BPV) for a lower data volume threshold (DVT).

11. The method of claim 10, wherein the base-station (gNB) updates the mapping between the data volume threshold (DVT) and the back off parameter values based on the load situation of the communication system.

12. The method of claim 11, wherein, if the load situation of the communication system is high, the base-station (gNB) configures a longer window for the higher data volume threshold (DVT).

13. The method of claim 12, wherein segmentation of the backoff parameter values results in at least 2 blocks.

14. An apparatus for congestion reducing performed by a user equipment (UE) in a wireless communication system, the apparatus comprising a wireless transceiver, a processor coupled with a memory in which computer program instructions are stored, said instructions being configured such that the user equipment (UE) is prepared for transmitting uplink data (UL) and is in a passive status and after initiating a Random Access Channel procedure (RACH) the user equipment (UE) receives a received back off index from a base-station (gNB) and the user equipment (UE) selects a selected back off Index based on user equipment (UE) criteria related to at least one communication system relevant criterion.

15. An apparatus for congestion reducing performed by a by a base station (gnB) in a wireless communication system, the apparatus comprising a wireless transceiver, a processor coupled with a memory in which computer program instructions are stored, said instructions being configured such that the base-station (gNB) configures a plurality of lower backoff parameter values (BPV) for a higher data volume threshold (DVT) and a plurality of higher backoff parameter values (BPV) for a lower data volume threshold (DVT).

16. (canceled)

17. (canceled)

18. (canceled)

19. (canceled)

20. (canceled)

21. The apparatus of claim 15, wherein the base-station (gNB) updates the mapping between the data volume threshold (DVT) and the back off parameter values based on the load situation of the communication system.

22. The apparatus of claim 21, wherein, if the load situation of the communication system is high, the base-station (gNB) configures a longer window for the higher data volume threshold (DVT).

23. The apparatus of claim 22, wherein segmentation of the backoff parameter values results in at least 2 blocks.
